(19) United States
(12) Patent Application Publication
(10) Pub. No.: US 2026/0138419 A1
(43) Pub. Date: May 21, 2026

(54) CONTROL METHOD USING ELECTRONIC EXPANSION VALVES TO REGULATE OIL CIRCULATION THROUGH REFRIGERANT SYSTEMS WITH MULTIPLE EVAPORATORS

(71) Applicant: Ford Global Technologies, LLC, Dearborn, MI (US)

(72) Inventors: Scott Thomas Vehige, Woodhaven, MI (US); Klaus Schuermanns, Cologne (DE); Claus Schmitz, Cologne (DE); Ruben Jean Boese, Köln (DE); Sven Gerling, Pulheim (DE)

(73) Assignee: Ford Global Technologies, LLC, Dearborn, MI (US)

(21) Appl. No.: 18/949,014

(22) Filed: Nov. 15, 2024

(51) Int. Cl. B60H 1/32

(52) U.S. Cl. CPC B60H 1/3214; B60H 1/323; B60H 2001/3285

(57) ABSTRACT

A method of purging oil from an evaporator of a refrigerant system. The refrigerant system includes a primary (first) evaporator and at least one auxiliary (second) evaporator. Both evaporators receive refrigerant from a compressor. The method includes adjusting an expansion valve to increase refrigerant flow through the auxiliary evaporator if oil or other liquid is likely to be trapped in the auxiliary evaporator to thereby purge oil from the auxiliary evaporator.

### FIELD OF THE DISCLOSURE

The present disclosure generally relates to a refrigerant system, and in particular to a refrigerant system that controls refrigerant flow through at least two evaporators or chillers whereby increased refrigerant flow through a selected one of the evaporators purges oil that may have accumulated in the evaporator.

### BACKGROUND OF THE DISCLOSURE

Heating, ventilation, and air conditioning systems (“HVAC” systems) may include a refrigerant system. Refrigerant systems may include a compressor that compresses refrigerant in the form of gas, and circulates refrigerant through a condenser and two or more evaporators. Condensers may cool and condense the refrigerant whereby the refrigerant forms a liquid that is evaporated in the evaporators. Expansion valves upstream of the evaporators may be controlled during operation of the refrigerant system. After the refrigerant exits the evaporators, the refrigerant is returned to the compressor. Oil may be utilized to lubricate the compressor. The oil may flow into one or more evaporators during operation of the refrigerant system.

### SUMMARY OF THE DISCLOSURE

A refrigerant system for vehicles according to an aspect of the present disclosure includes a compressor and a condenser that receives refrigerant from the compressor. The refrigerant system further includes first and second expansion valves that receive refrigerant from the condenser. A first evaporator receives refrigerant from the first expansion valve and returns refrigerant to the compressor. A second evaporator receives refrigerant from the second expansion valve and returns refrigerant to the compressor. The refrigerant system further includes a controller that is configured to: 1) utilize a primary control mode to control a position of the first expansion valve through a range of operating positions as required to meet thermal demands during operation of the refrigerant system, and: 2) utilize a purge mode to adjust a position of the first expansion valve to a position that decreases refrigerant flow through the first evaporator and increases refrigerant flow through the second evaporator sufficiently to purge oil from the second evaporator.

Embodiments of the first aspect of the present disclosure can include any one or a combination of the following features:
The controller is optionally configured to revert from the purge mode to the primary control mode if cooling performance of the first evaporator has degraded according to predefined criteria during the purge mode.
The predefined criteria optionally comprises a temperature of refrigerant.
The predefined criteria optionally comprises a temperature of refrigerant exiting the first evaporator that is above a predefined temperature.
The controller is optionally configured to revert from the purge mode to the primary control mode after a predefined period of time from the start of the purge mode.
The controller is optionally configured to revert from the purge mode to the primary control mode even if cooling performance of the first evaporator has not degraded according to the predefined criteria during the purge mode.
The predefined criteria optionally comprises a period of time since the end of a previous purge mode.
The controller is optionally configured to alternate between the primary control mode and the purge mode at predefined time intervals.
The first evaporator optionally comprises a primary evaporator that is configured to cool air or coolant that is supplied to a cabin or battery of a motor vehicle.
The refrigerant system may include first and second fluid lines fluidly connecting the first and second expansion valves, respectively, to an outlet of the condenser whereby adjusting a position of the first expansion valve reduces refrigerant flow through the first fluid line and increases refrigerant flow through the second refrigerant line.
The controller is optionally configured to revert from the purge mode to the primary control mode if predefined oil purge criteria is satisfied.
The predefined oil purge criteria may be determined, at least in part, by testing a refrigerant system to determine a combination of operating parameters indicative of satisfactory oil purge from the second evaporator.

Another aspect of the present disclosure is a method of purging oil from an auxiliary evaporator of a refrigerant system having a primary evaporator and an auxiliary evaporator that both receive refrigerant from a compressor. The method includes adjusting an expansion valve to increase refrigerant flow through the auxiliary evaporator if oil is likely to be trapped in the auxiliary evaporator to thereby purge oil from the auxiliary evaporator.

Embodiments of the second aspect of the present disclosure can include any one or a combination of the following features:
After the primary expansion valve is adjusted to increase refrigerant flow through the auxiliary evaporator, the expansion valve may be adjusted to decrease refrigerant flow through the auxiliary evaporator if predefined criteria are satisfied.
The predefined criteria may optionally comprise a temperature of refrigerant exiting the primary evaporator that is greater than a threshold temperature.
The predefined criteria optionally comprises a period of time since the expansion valve has been adjusted to increase refrigerant flow through the auxiliary evaporator.
The refrigerant system optionally includes first and second expansion valves that control refrigerant flow from the compressor to the primary and auxiliary evaporators, respectively. The first expansion valve is optionally adjusted to increase refrigerant flow through the auxiliary evaporator by reducing refrigerant flow through the primary evaporator.

Another aspect of the present disclosure is a motor vehicle including a refrigerant system that is configured to heat and/or cool a cabin or battery of the motor vehicle. The refrigerant system includes a compressor and a condenser that receives refrigerant from the compressor. The refrigerant system further includes first and second expansion valves that receive refrigerant from the condenser. A first evaporator receives refrigerant from the first expansion valve and returns refrigerant to the compressor. A second evaporator receives refrigerant from the second expansion valve and returns refrigerant to the compressor. The refrigerant system further includes a controller that is configured to 1) utilize a primary control mode to control a position of the first expansion valve through a range of operating positions as required to meet thermal demands during normal operation of the refrigerant system, and 2) utilize a purge mode to adjust a position of the first expansion valve to a position that is outside of a lower bound of the range of operating positions if accumulation of oil in the second evaporator is likely according to predefined criteria to thereby decrease refrigerant flow through the first evaporator and increase refrigerant flow through the second evaporator to purge oil in the second evaporator.

Embodiments of the third aspect of the present disclosure can include any one or a combination of the following features:
The first evaporator is optionally configured to cool air or coolant that is supplied to a cabin or battery of the motor vehicle.
The controller is optionally configured to revert from the purge mode to the primary control mode if cooling performance of the first evaporator has degraded sufficiently according to predefined criteria.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a partially schematic plan view of a motor vehicle according to an aspect of the present disclosure;

FIG. 2 is a diagram of a refrigerant system according to an aspect of the present disclosure; and

FIG. 3 is a flow chart showing a method of purging oil from an evaporator according to an aspect of the present disclosure.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

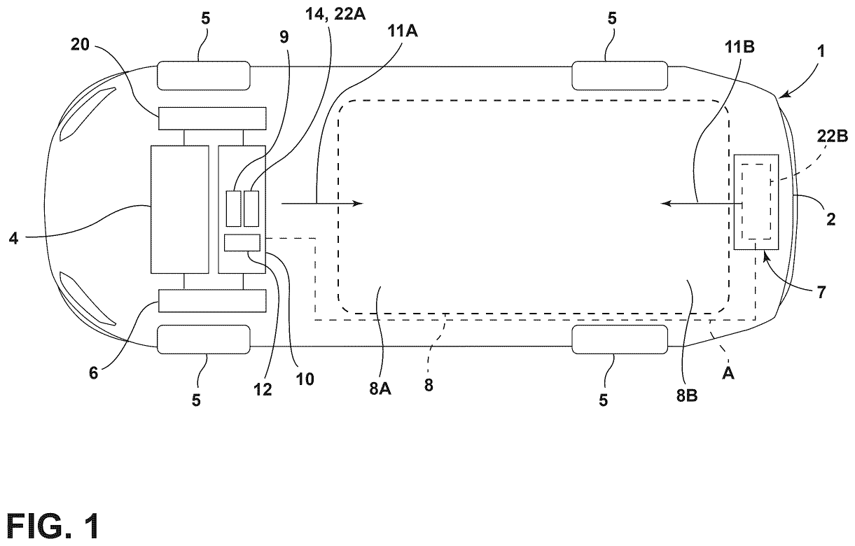

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a refrigerant system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the terms “or” and “and/or,” when used in a list of two or more items, means that any one of the listed items can be employed by itself, or any combination of two or more of the listed items can be employed. For example, if a composition or device is described as containing or comprising components A, B, and/or C, the composition or device can contain (include) A alone; B alone; C alone; A and B in combination; A and C in combination; B and C in combination; or A, B, and C in combination. If a composition or device is described as containing or comprising components A and/or B and/or C, the composition or device can contain (include) A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” “including” or any other variation thereof, are intended to cover a non-exclusive inclusion, such that a process, method, article, or apparatus that includes or comprises a list of elements does not include only those elements but may include other elements not expressly listed or inherent to such process, method, article, or apparatus. An element preceded by “comprises . . . a” or “includes . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

With reference to FIG. 1, a motor vehicle according to an aspect of the present disclosure includes a body 2 and a passenger space or cabin 8. Vehicle 1 includes a powered drive system 4 that is operably coupled to one or more wheels 5 to move the vehicle 1. The power drive system 4 may comprise an electric drive, a combustion engine, or a combination thereof. Vehicle 1 may include a voltage source 20. The voltage source 20 may comprise a high voltage (HV) battery if the power drive 4 includes an electric motor. Vehicle 1 further includes a controller 6 that may be operably interconnected to the power drive 4 and a refrigerant system 10. Controller 6 may comprise a plurality of individual controllers that are operably interconnected by one or more networks, and may optionally include a control module that is specifically configured to control refrigerant system 10. It will be understood, however, that the present disclosure is not limited to any specific control arrangement. Refrigerant system 10 may include fan 9 (“HVAC blower”) that circulates air over or through one or more heat exchangers such as a first (primary) evaporator 22A to supply conditioned air 11A to a front portion 8A of cabin 8. As discussed below, system 10 may include a rear HVAC system 7 having second evaporator 22B that may be located in a rear portion of vehicle 1 to provide conditioned air 11B to a rear portion 8B of cabin 8. Second evaporator 22B may be fluidly connect to a compressor 12 and condenser 14 by refrigerant lines A.

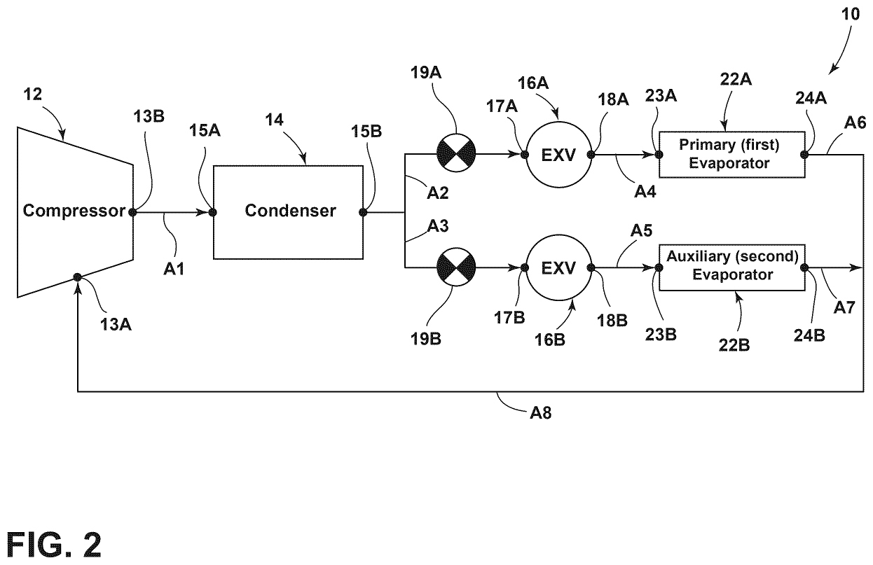

With further reference to FIG. 2, refrigerant system 10 may include a compressor 12, a condenser 14, first and second expansion valves 16A and 16B, and a primary evaporator 22A and an auxiliary evaporator 22B. Compressed and heated refrigerant (gas) from compressor 12 may flow from an outlet 13B of compressor 12 to an inlet 15A of condenser 14 through a refrigerant line A1. As the refrigerant flows through condenser 14, it is cooled to form vapor and/or liquid. After the refrigerant flows through condenser 14, the refrigerant flows from an outlet 15B of condenser 14 to inlets 17A and 17B of expansion valves 16A and 16B through refrigerant lines A2 and A3. Refrigerant from expansion valve 16A flows from an outlet 18A of expansion valve 16A to an inlet 23A of evaporator 22A through a refrigerant line A4. After the refrigerant flows through evaporator 22A, the refrigerant flows from outlet 24A of evaporator 22A through a refrigerant line A6, and the refrigerant then flows through a refrigerant line A8 to inlet 13A of compressor 12.

Refrigerant flows from outlet 18B of expansion valve 16B to inlet 23B of evaporator 22B through a refrigerant line A5, and refrigerant exits evaporator 22B at outlet 24B and flows through refrigerant lines A7 and A8 to inlet 13A of compressor 12.

Expansion valves 16A and 16B may comprise electrically controlled valves (“EXV”) that are operably connected to controller 6. Alternatively, at least one of the expansion valves (typically 16B and other expansion valves for auxiliary evaporators) may comprise a thermal expansion valve (“TXV”) that is not directly controlled by controller 6, but rather responds to pressure inputs from the refrigerant after the refrigerant has expanded. Thus, if expansion valve 16B comprises a thermal expansion valve (TXV), it responds to changing operating conditions, but it is not directly controlled by controller 6.

Refrigerant system 10 may include valves 19A and/or 19B to control flow of refrigerant to expansion valves 16A, 16B and evaporators 22A, 22B (and additional evaporators). Valves 19A and 19B may be operably connected to controller 6, and they may be used to control flow of refrigerant. For example, if evaporator 22B is not in use (e.g. the rear portion 8B of cabin 8 does not require cooling), valve 19B may be closed whereby no refrigerant flows to evaporator 22B.

The refrigerant system 10 may include additional evaporators as required for a particular application. Examples of refrigerant systems that may be utilized in connection with an oil purge according to an aspect of the present disclosure include U.S. Patent Application Publication Nos. 2022/0410664 A1 and 2022/0412611 A1, each of which are incorporated herein by reference. In general, refrigerant system 10 may comprise an air conditioner (AC) system, or it may comprise a heat pump system that can be utilized to both heat and cool one or more components of vehicle 1. For example, if refrigerant system 10 comprise a heat pump, it may be utilized to heat and cool air that is supplied to passenger space 8, and it may also be utilized to heat and cool an HV battery 20 utilizing liquid coolant. For example, liquid coolant or air can be heated by condenser 14 to heat passenger space 8, battery 20, or other components, and air or liquid coolant can be cooled by one or more evaporators 22A, 22B, etc. to thereby cool air that is supplied to passenger space 8, or cool liquid coolant to cool HV battery 20. It will be understood that, as used herein “evaporator” may generally refer to refrigerant-to-air and refrigerant-to-coolant (liquid) heat exchangers (“chillers”) or other evaporative devices whereby liquid refrigerant undergoes a phase change from liquid to vapor.

Oil or other lubricant may be utilized to lubricate compressor 12. During operation, the oil may circulate through the system 10 with the refrigerant. As used herein the term “oil” generally refers to any liquid such (e.g. a lubricant) that may accumulate in the evaporators. Typically, the expansion valves 16A and 16B control flow of refrigerant through the evaporators 22A and 22B as required to meet the thermal demands of normal operation. Thus, the expansion valves 16A and 16B typically move through a range of positions including minimum and maximum open positions corresponding to minimum and maximum refrigerant mass flow rates that are required to meet the thermal demands of the evaporators 22A and 22B. If evaporator 22A comprises a primary evaporator, evaporator 22A may experience a greater mass flow rate of refrigerant compared to auxiliary evaporator 22B during normal operation. For example, during normal operation, expansion valve 16A may provide an increased mass flow rate of refrigerant to evaporator 22A compared to a mass flow rate of refrigerant to evaporator 22B by expansion valve 16B. Due to the increased mass flow rate of refrigerant through evaporator 22A during normal operation, oil entrained in the refrigerant will tend to flow out of evaporator 22A rather than accumulating in evaporator 22A. However, if evaporator 22B experiences a lower mass flow rate of refrigerant during normal operation (e.g. expansion valve 16B restricts refrigerant flow), oil may accumulate in evaporator 22B. It will be understood that system 10 may include additional evaporators (e.g. additional auxiliary evaporators) that may also operate with insufficient refrigerant mass flow to purge (clear) oil during normal operation. As noted above, the term “oil” as used herein may refer to virtually any liquid that may be entrained in refrigerant flowing through the evaporators whereby the liquid accumulates in one or more evaporators during normal operation of the system 10.

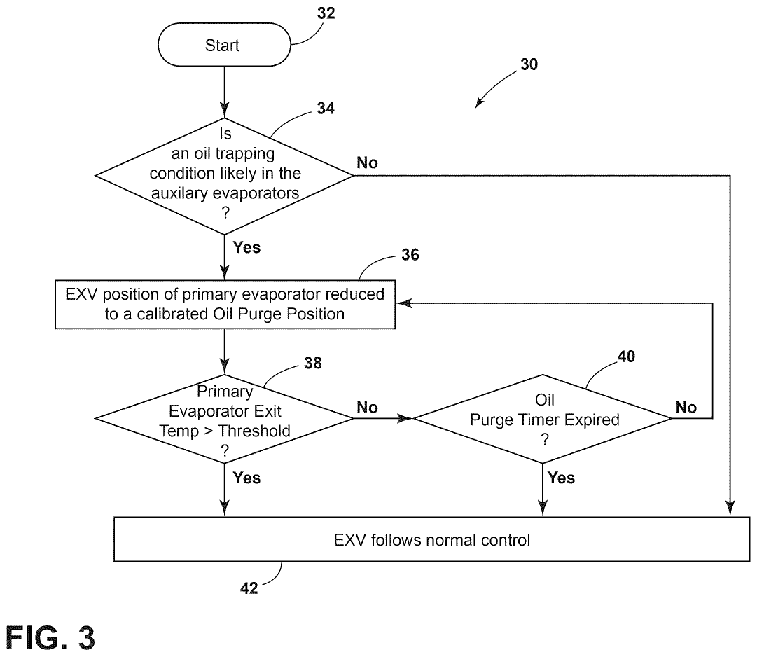

With further reference to FIG. 3, a process or method 30 may be utilized to at least partially purge oil that has accumulated in one or more evaporators of system 10. Method 30 may be implemented by a programmable controller or the like (e.g. controller 6) that is configured to execute the steps of method 30. Method 30 may comprise a purge mode or cycle that begins at START 32 and ends when primary or normal (non-purge) operation of system 10 is resumed at step 42. Following START 32, at step 34 method 30 includes determining if an oil trapping condition is likely in one or more evaporators such as auxiliary or second evaporator 22B (FIG. 2). The presence of an oil trapping condition (“entry condition”) may be determined utilizing various predefined criteria. In general, the evaporator 22B will only trap oil if it is in operation. Thus, if there has been no flow of refrigerant to evaporator 22B (e.g. valve 19B is closed), method 30 will proceed to normal control (step 42). Examples of operating parameters that may indicate an oil trapping condition is likely may include one more of: 1) the compressor speed is below a predefined threshold; 2) the speed of HVAC blower 9 (FIG. 1) is below a predefined threshold; and 3) the ambient temperature is below a predefined threshold. When the compressor speed, ambient temperature, and HVAC blower are all high, there is typically significant mass flow through evaporator 22B and good oil return to compressor 12.

The oil trapping criteria utilized at step 34 may comprise, for example, a period of time (e.g. a time that system 10 has been operating) since a prior oil purge cycle according to process 30. It will be understood that controller 6 may be configured to simultaneously implement method 30 for multiple auxiliary evaporators whereby method 30 may be implemented for multiple evaporators when each evaporator meets the criteria at step 34. In general, each evaporator may separately purged in sequence at the time each evaporator satisfies the criteria of step 34. If an oil trapping condition is not likely at step 34, process 30 returns to step 42 and the control of expansion valves 16A and 16B follows a normal control scheme (i.e., a control scheme that meets the thermal demands on system 10 but is not specifically configured to purge oil from one or more evaporators).

However, if an oil trapping condition is likely at step 34, process 30 then proceeds to step 36, and a position of expansion valve 16A (FIG. 2) is adjusted (reduced) to a calibrated oil purge position. In general, the calibrated oil purge position of expansion valve 16A may comprise a valve position that is more restrictive than a position that would be expected to occur during normal operation of system 10. During normal operation, expansion valve 16A may move through a range of use positions wherein the range is bounded by minimum and maximum positions that may expressed as a percentage (%) of the fully open position. Thus, the upper and lower bounds of the expansion valve position for normal use of the system 10 are typically not equal to the mechanical completely closed (0%) or completely open (100%). The position of expansion valve 22A when it is restricted may comprise a % (e.g. 10% or 20%) that is well below the minimum required to meet the thermal demands of the system during normal operation (e.g. 30% or 40%). In general, the primary EXV (expansion valve 16A) may be restricted to very low levels which would not be used in normal operation because the refrigerant temperature becomes unstable when expansion valve 22A is highly restricted. The oil return from evaporator 22A is also temporarily reduced when flow through expansion valve 22A is highly restricted. Thus, method 30 temporarily “sacrifices” the performance of one evaporator (evaporator 22A) to perform a maintenance procedure on the second evaporator 22B or other auxiliary evaporators. However, in some cases, the calibrated oil purge position may alternatively comprise a valve position that provides a sufficient mass flow rate of refrigerant through evaporator 22B to thereby purge oil from evaporator 22B that is within the normal range of valve positions. Thus, the calibrated oil purge position of expansion valve 16A may be within a range of valve positions countered during normal operation if such range includes a valve position that is sufficient to purge oil from evaporator 22B.

After shifting the expansion valve 16A to a calibrated oil purge position, system 10 operates in a purge mode or condition whereby flow of refrigerant through evaporator 22A is restricted, and flow of refrigerant through evaporator 22B is increased to thereby purge oil from evaporator 22B. During the purge operation, the system 10 may be configured to monitor one or more parameters of the system 10 to determine if thermal performance of primary evaporator 22 has been reduced to an unacceptable level. For example, if evaporator 22A is utilized to provide cool air to a passenger space of a vehicle, system 10 may be configured to return to normal control 42 if a temperature of air being supplied to a cabin increases above an acceptable level. The acceptable level may be determined by testing to determine what levels are considered unacceptable by users. Alternatively, step 38 may comprise determining if a temperature of refrigerant exiting outlet 24A of evaporator 22A is greater than a threshold temperature, whereby control returns to a normal control mode 42 if the temperature of the refrigerant exiting evaporator 22A is above the threshold.

However, if the decrease in cooling performance at step 38 does not exceed a predefined threshold/criteria, the process continues to step 40, and the system determines if an oil purge timer has expired. The oil purge timer may comprise a period of time since the expansion valve has been shifted to a calibrated oil purge position at step 36. If the oil purge timer has not expired, the process returns to step 36 and system 10 continues to operate in an oil purge mode. However, if the oil purge timer has expired at step 40, the process returns to normal expansion valve control 42.

Method 30 may comprise checking if entry conditions for oil purge are likely at step 34, then start a timer (e.g. 5 minutes) if an oil purge cycle is required. As discussed above, the entry conditions define when the oil trapping is most severe (most likely). The oil purge routine (mode) will run for 5 minutes every hour or other period of time, wherein the period of time is tunable. This avoids running the purge routine if it isn't necessary. For example, if the rear HVAC system 7 has been turned off for an extended period of time there is no need to purge evaporator 22B. The system is also configured to reset the timer or stop the timer if the entry conditions (step 34) are removed. For example, low compressor speed may be an entry condition to start the timer, as this reduces the mass flow. If the compressor 12 increases its speed this will tend to have an oil purging affect whereby it is not necessary to restrict flow through expansion valve 16A, and the timer is therefore stopped while the compressor speed is high (i.e. above a predefined speed).

In general, the purge cycle or method 30 may involve restricting flow of refrigerant through expansion valve 16A (FIG. 2) (or additional expansion valves associated with additional evaporators) without adjusting a position of expansion valve 16B. However, if expansion valve is controlled by controller 6, a position of expansion valve 16B may also be adjusted to provide increased refrigerant flow through evaporator 22B while flow through expansion valve 16A is restricted. If system 10 includes additional auxiliary evaporators, the expansion valves of these additional auxiliary evaporators may optionally be adjusted to provide sufficient refrigerant mass flow through a specific evaporator as required to purge the oil therefrom.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A refrigerant system for vehicles comprising:
a compressor;
a condenser that receives refrigerant from the compressor;
first and second expansion valves that receive refrigerant from the condenser;
a first evaporator that receives refrigerant from the first expansion valve and returns refrigerant to the compressor;
a second evaporator that receives refrigerant from the second expansion valve and returns refrigerant to the compressor; and
a controller configured to:
1) utilize a primary control mode to control a position of the first expansion valve through a range of operating positions as required to meet thermal demands during normal operation of the refrigerant system; and
2) utilize a purge mode to adjust a position of the first expansion valve to a position that decreases refrigerant flow through the first evaporator and increases refrigerant flow through the second evaporator sufficiently to purge oil from the second evaporator.

2. The refrigerant system of claim 1, wherein:
the controller is configured to revert from the purge mode to the primary control mode if cooling performance of the first evaporator has degraded according to predefined criteria during the purge mode.

3. The refrigerant system of claim 2, wherein:
the predefined criteria comprises a temperature of refrigerant.

4. The refrigerant system of claim 3, wherein:
the predefined criteria comprises a temperature of refrigerant exiting the first evaporator that is above a predefined temperature.

5. The refrigerant system of claim 2, wherein:
the controller is configured to revert from the purge mode to the primary control mode after a predefined period of time.

6. The refrigerant system of claim 5, wherein:
the controller is configured to revert from the purge mode even if cooling performance of the first evaporator has not degraded according to the predefined criteria during the purge mode.

7. The refrigerant system of claim 1, wherein:
the predefined criteria comprises a period of time since a previous purge mode.

8. The refrigerant system of claim 1, wherein:
the controller is configured to alternate between the primary control mode and the purge mode.

9. The refrigerant system of claim 1, wherein:
the first evaporator comprises a primary evaporator that is configured to cool air or coolant that is supplied to a cabin or battery of a motor vehicle.

10. The refrigerant system of claim 1, wherein:
first and second fluid lines fluidly connecting the first and second expansion valves, respectively, to an outlet of the condenser whereby adjusting a position of the first expansion valve reduces refrigerant flow through the first fluid line and increases refrigerant flow through the second refrigerant line.

11. The refrigerant system of claim 1, wherein:
the controller is configured to revert from the purge mode to the primary control mode if predefined oil purge criteria is satisfied.

12. The refrigerant system of claim 11, wherein:
the predefined oil purge criteria is determined, at least in part, by testing a refrigerant system to determine a combination of operating parameters indicative of satisfactory oil purge from the second evaporator.

13. A method of purging oil from an auxiliary evaporator of a refrigerant system having a primary evaporator and an auxiliary evaporator that receive refrigerant from a compressor, the method comprising:
adjusting an expansion valve to increase refrigerant flow through the auxiliary evaporator if oil is likely to be trapped in the auxiliary evaporator to thereby purge oil from the auxiliary evaporator.

14. The method of claim 13, including:
after adjusting the expansion valve to increase refrigerant flow through the auxiliary evaporator, adjusting the expansion valve to decrease refrigerant flow through the auxiliary evaporator if predefined criteria are satisfied.

15. The method of claim 14, wherein:
the predefined criteria comprises a temperature of refrigerant exiting the primary evaporator that is greater than a threshold temperature.

16. The method of claim 14, wherein:
the predefined criteria comprises a period of time the expansion valve has been adjusted to increase refrigerant flow through the auxiliary evaporator.

17. The method of claim 13, wherein:
the refrigerant system includes first and second expansion valves that control refrigerant flow from the compressor to the primary and auxiliary evaporators, respectively, and wherein:
the first expansion valve is adjusted to increase refrigerant flow through the auxiliary evaporator by reducing refrigerant flow through the primary evaporator.

18. A motor vehicle including a refrigerant system that is configured to heat and/or cool a cabin of the motor vehicle, the refrigerant system comprising:
a compressor;
a condenser that receives refrigerant from the compressor;
first and second expansion valves that receive refrigerant from the condenser;
a first evaporator that receives refrigerant from the first expansion valve and returns refrigerant to the compressor; and
a second evaporator that receives refrigerant from the second expansion valve and returns refrigerant to the compressor;
a controller configured to:
1) utilize a primary control mode to control a position of the first expansion valve through a range of operating positions as required to meet thermal demands during normal operation of the refrigerant system; and
2) utilize a purge mode to adjust a position of the first expansion valve to a position that is outside of a lower bound of the range of operating positions if accumulation of oil in the second evaporator is likely according to predefined criteria to thereby decrease refrigerant flow through the first evaporator and increase refrigerant flow through the second evaporator to purge oil in the second evaporator.

19. The motor vehicle of claim 18, wherein:
the first evaporator is configured to cool air or coolant that is supplied to a cabin or battery of the motor vehicle.

20. The motor vehicle of claim 18, wherein:
the controller is configured to revert from the purge mode to the primary control mode if cooling performance of the first evaporator has degraded sufficiently according to predefined criteria.
